(19) United States
(12) Patent Application Publication
(10) Pub. No.: US 2026/0297281 A1
(43) Pub. Date: Oct. 1, 2026

(54) COLOR GETTERS FOR COLOR REMOVAL IN SOLVENT-BASED PLASTIC RECYCLING

(71) Applicant: Wisconsin Alumni Research Foundation, Madison, WI (US)

(72) Inventors: George Huber, Middleton, WI (US); Charles Granger, Madison, WI (US); Tianwei Yan, Madison, WI (US)

(73) Assignee: Wisconsin Alumni Research Foundation, Madison, WI (US)

(21) Appl. No.: 19/566,683

(22) Filed: Mar. 13, 2026

Related U.S. Application Data
(60) Provisional application No. 63/772,105, filed on Mar. 14, 2025.

(51) Int. Cl. C08J 11/06; B29B 17/00; B29B 17/02; B29K 23/00; B29L 7/00

(52) U.S. Cl. CPC C08J 11/06; B29B 17/0026; B29B 17/02; B29B 2017/0217; B29B 2017/0293; B29K 2023/06; B29K 2023/12; B29L 2007/008; C08J 2323/06; C08J 2323/12; C08J 2427/06; C08J 2429/04; C08J 2475/04

(57) ABSTRACT

A method of removing colored contaminants from a polymer solution. The method includes adding to the polymer solution a “getter” compound or composition in an amount and for a time and at a temperature wherein at least a portion of a colored contaminant in the solution is agglomerated and/or precipitated, thereby yielding a treated solution. The treated solution may then optionally be mechanically filtered to remove the agglomerated and/or precipitated contaminants.

### FEDERAL FUNDING STATEMENT

This invention was made with government support under DE-EE0009285 awarded by the US Department of Energy. The government has certain rights in the invention.

### BACKGROUND

Over the last ~70 years, plastic materials have become indispensable to modern society beginning with their large-scale production. Their durability, low cost, and versatility have driven an exponential growth of plastics production. However, this growth has led to end-of-life issues, such as waste accumulation and environmental plastics contamination.

Flexible plastic packaging is particularly challenging to recycle as it typically includes several layers of distinct polymers for their moisture and oxygen barrier properties, sealability, and mechanical strength. Tie layers, adhesives, additives, and inks add further complexity to the composition, resulting in incompatibility with traditional recycling technologies. Ineffective separation and purification of different polymers result in downgraded recyclates with deteriorated properties.

Virgin plastics are usually colorless plastic materials while inks are typically added to most plastics to improve the aesthetic demands for products. After mechanical recycling, colorants often cause recycled plastics to appear gray or black, making them distinguishable from colorless virgin plastics. A recent report evaluated mechanically recycled low-density polyethylene (LDPE) printed flexible packaging with pigments and ink binders. The results indicated that the presence of ink introduced yellowish or brownish tones to the recycled films as well as reduced transparency and pigment aggregates, e.g., “black specks.”

Color removal from recycled polymers is difficult because the high color strength of colorant species and high color sensitivity of human eyes lead to recognizable color in the recycled plastic materials even with minimal retention of colorants. The retained colors can adversely affect customer perception of the recycled plastic products. For example, yellow color is commonly associated with age and degradation. The adverse impact of colors in recycled resins is reflected in the price difference between colored and colorless postconsumer plastic. Taking high-density polyethylene (HDPE) as an example, the price of mixed color HDPE bales is one-half to one-third of colorless baled HDPE. Therefore, effective removal of colors from recycled polymers is critical for improving the product value of recyclates.

Colorants are diverse in chemical compositions and physical properties and are classified as pigments or dyes. Pigments are designed to reside in discrete particles while dyes are designed to be soluble in solvents. For plastic packaging printing, organic pigment-based inks are most common because dyes tend to bleed and leach with incompatible plastics. Pigments require binders and additives in the inks to disperse properly on printed areas. A myriad of chemical compositions and structural variants bring distinct physical and chemical properties, making it challenging to remove all pigments with one single method.

Deinking pretreatments have been developed to remove inks from a plastic's surface. However, when ink is printed on an inner layer of flexible packaging (i.e., reverse-printed laminated films), the effectiveness and rate of deinking are compromised. Consequently, recycling technologies are emerging to create higher-quality recycled plastics. Dissolution-based recycling has gained interest as a complementary method to traditional mechanical recycling. This approach can extract valuable polymer components from multilayer films and remove additives and impurities with distinct solubilities (e.g., pigments). For example, a process referred to as solvent-targeted recovery and precipitation (STRAP) has been developed to recover components from multilayer plastic films or mixed plastic wastes through selective dissolution of individual plastic components guided by thermodynamic calculations of polymer solubility.

Despite these advances, effective removal of colors in plastic recycling processes remains a significant challenge. The present disclosure addresses this unmet need by providing methods for removing colored contaminants from dissolved plastic polymers in solvent-based recycling systems.

### SUMMARY

Provided herein are methods for removing color contaminants from plastic waste by adding one or more compounds that function as “getters” into a dissolved polymer solution. The getters promote agglomeration and/or precipitation of pigment particles and other finely dispersed contaminants, thereby increasing their effective particle size and enhancing their removal through mechanical separation.

The disclosed methods may be applied in a variety of solvent-based plastic recycling processes (e.g., STRAP processes). In addition to pigments, the method may also be used to remove other dispersed fillers, including carbon black, metal oxides, and similar particulate contaminants.

Specifically, disclosed and claimed herein is a method of removing colored contaminants from a solution comprising a dissolved polymer and at least one colored contaminant, the method comprising:
(a) adding to the solution a getter material in an amount and for a time and at a temperature wherein at least a portion of a colored contaminant in the solution is agglomerated and/or precipitated, thereby yielding a treated solution.

The method may further comprise, after step (a):
(b) filtering the treated solution to remove at least a portion of the agglomerated and/or precipitated colored contaminant.

The getter material may comprise a material suitable for use as an ink binder or adhesive.

In preferred versions, the getter material comprises a polymer. The polymer may be a synthetic organic polymer. In certain embodiments, the polymer is selected from the group consisting of polyurethane (PU), polyvinyl acetate (PVAc), polyvinyl alcohol (PVA), polyvinyl chloride (PVC), polypropylene (PP), high-density polyethylene (HDPE), other polyolefins, and combinations thereof.

The getter materials may be added to the solution in any suitable form. In certain embodiments, the getter material is added in the form of a liquid solution. For example, the getter material may be dissolved in a second solvent prior to addition to the solution, and may reprecipitate upon contact with the solution. In other embodiments, the getter material is added in solid form. Alternatively, the getter material may be introduced by adding a waste stream comprising the getter material.

The conditions of step (a) are not particularly limited and may be selected based on the composition of the system. In exemplary embodiments, the getter material is added in an amount of about 0.1 wt % to about 40 wt % relative to the dissolved polymer. The temperature of step (a) may range from about 50° C. to about 200° C., and the contact time may range from about 10 minutes to about 48 hours.

Preferably, step (a) is conducted with agitation to promote interaction between the getter material and the colored contaminants. In certain embodiments, the agitation is conducted in the presence of inert solid agitation media, such as glass beads.

The method may further comprise, after step (b):
(c) precipitating at least a portion of the dissolved polymer from the filtered solution.

The dissolved polymer may be derived from multilayer plastic films or mixed plastic wastes. In certain embodiments, the dissolved polymer comprises a polyolefin.

The objects and advantages of the disclosure will appear more fully from the following detailed description of the preferred embodiment of the disclosure made in conjunction with the accompanying drawings.

### BRIEF DESCRIPTION OF THE DRAWINGS

FIG. 1 is a schematic diagram illustrating the basic concept of using “getter” compounds to help remove colored contaminants from a solution containing a dissolved plastic polymer.

FIG. 2 is a series of photographs of compressed LDPE films containing adhesive and/or ink extenders before and after STRAP. The films included various formulations of unpigmented inks (extenders) and polyurethane (PU) adhesives that are commonly used in printed multilayer films.

FIG. 3 shows results from a first series of experiments evaluating PU as a getter. From left to right, the samples show hot polyethylene (PE)/dodecane solutions (120° C.) treated with (i) PU dissolved in dimethylformamide (DMF) and reprecipitated as fine particles upon contact with hot dodecane, (ii) PU-containing plastic waste, and (iii) PU pellets. The mixtures were stirred at about 600 rpm for about two days. The photographs were taken while the solutions remained hot.

FIG. 4 shows results from a second series of experiments evaluating PU as a getter using PU/DMF solutions at different concentrations (see Table 1). The PU/DMF solution was added dropwise to PE/dodecane solutions at 120° C. The mixtures were stirred at about 800 rpm for about 18 hours. The upper panel presents photographs of the original PE solution and samples treated with three different PU/DMF concentrations (Batches 1, 2, and 3). The lower panel presents photographs of the dried PE recovered after treatment of the respective batches.

FIG. 5 shows results from a third series of experiments evaluating PU as a getter using PU/DMF solutions at reduced PU loadings, lower PU solution concentrations, and shorter contact times (see Table 2). The upper panel presents samples treated with 1 mL of 1/20, 1/40, and 1/80 g PU per ml DMF solutions after about 30 minutes of stirring. The lower panel presents the same samples after about 3 hours of stirring, followed by 10 minutes of settling of the precipitates.

FIG. 6 shows the results of filtering PE samples treated under the conditions listed in Table 2. The upper panel presents the treated mixture after filtration through a 500 μm mesh to remove agglomerated and/or precipitated colored particulates. The lower panel presents dried PE resins from an untreated control sample compared with PE samples treated with PU.

FIG. 7 presents photographs of polymer films cast from untreated recycled PE and from recycled PE treated with PU in accordance with the disclosed method. As shown in the figure, the PU-treated samples exhibit substantially reduced coloration compared to the untreated recycled PE.

FIG. 8 presents a series of photographs illustrating the use of a getter comprising a mixture of polyvinyl acetate, polyvinyl alcohol, and propylene glycol in water emulsion, namely Elmer's® Glue-All®-brand glue (registered trademarks of Sanford LP, Atlanta, Georgia, US). The photographs show the cooled PE slurry after addition of the adhesive at 120° C.

FIG. 9 presents a series of photographs illustrating the use of polyvinyl acetate (PVAc) as a getter. PVAc was dissolved in ethyl acetate (EtOAc) and added to a hot PE solution. The upper panel shows the starting PE solution prior to addition of PVAc. The lower panel shows, on the left, the hot PE solution after addition of the PVAc solution, and on the right, the resulting slurry after cooling.

FIG. 10 presents a series of photographs illustrating the use of polyvinyl chloride (PVC) as a getter. The upper panel shows the starting PE solution prior to addition of PVC. The lower panel shows, from left to right, a control PE solution agitated with glass beads in the absence of PVC, the cooled PE solution after addition of PVC powder, PVC powder agitated in the presence of glass beads, and PVC dissolved in tetrahydrofuran (THF) prior to addition.

FIG. 11 shows films made from LDPE-TiO₂ (~2 wt % TiO₂), and the LDPE recovered after treatment with PP getters. The LDPE-TiO₂ was dissolved in n-octane at 125° C. Next, PP was added to the solution. Both LDPE and PP were soluble in n-octane at 125° C. After dissolution of the PP, stirring was stopped, and the solution was allowed to cool to 70° C. to precipitate both LDPE and PP. Following precipitation, the solution was reheated to 90° C., where the LDPE was soluble, but the PP was not. The solution was then filtered at 90° C. through a 25-μm filter. Also presented are the results from an ash analysis performed following ASTM D5630, which show the reduction in TiO₂ after treatment with PP getters.

### DETAILED DESCRIPTION

### Abbreviations and Definitions

DMF=Dimethylformamide; EtOAc=Ethyl acetate; HDPE=High-density polyethylene; LDPE=Low-density polyethylene; PP=Polypropylene, NC=Nitrocellulose; PE=Polyethylene; PTFE=Polytetrafluoroethylene; PU=polyurethane; PVA=Polyvinyl alcohol; PVAc=Polyvinyl acetate; PVC=Polyvinyl chloride; STRAP=Solvent-targeted recovery and precipitation; THF=Tetrahydrofuran.

As used herein, the term “about” refers to +10% of the variable referenced.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

As used herein, the singular forms “a,” “an,” and “the” include plural referents unless the content clearly dictates otherwise.

As used herein, the term “or” is an inclusive “or” operator and is equivalent to the term “and/or” unless the context clearly dictates otherwise.

The elements and method steps described herein can be used in any combination whether explicitly described or not, unless otherwise specified or clearly implied to the contrary by the context in which the referenced combination is made.

All combinations of method steps as used herein can be performed in any order, unless otherwise specified or clearly implied to the contrary by the context in which the referenced combination is made.

The method disclosed herein may comprise, consist of, or consist essentially of the various steps and equipment disclosed herein. The disclosure provided herein suitably may be practiced in the absence of any element which is not specifically disclosed herein.

It is understood that the disclosure is not confined to the particular elements and method steps herein illustrated and described, but embraces such modified forms thereof as come within the scope of the claims.

As used herein, the term “getter” refers to a material that interacts with one or more colored contaminants present in a dissolved polymer solution so as to increase the removability of the colored contaminants from the solution. Such interaction may occur through one or more mechanisms including, without limitation, agglomeration, coagulation, precipitation, bridging, adhesion, complex formation, adsorption, or combinations thereof. In certain embodiments, the getter facilitates agglomeration and/or precipitation of at least a portion of the colored contaminants.

As used herein, the term “colored contaminant” refers to any chromophoric species capable of imparting visible color including black and white to a polymer or polymer solution, including, without limitation, pigments, dyes, pigment decomposition products, carbonaceous materials (e.g., carbon black), metal oxides, or combinations thereof.

### Color Removal Using Getters

In solvent-based plastic recycling processes, ink pigments in multilayer plastic films may be removed by selecting a solvent with low solubility of ink pigments and their decomposition products, optionally in combination with additional filtering steps. See e.g., U.S. Patent Application Publication No. 2025/0353218 A1. This approach is generally effective for printed plastic films that typically include binders and/or additives. However, colored rigid plastics commonly contain pigments and other fillers that are incorporated directly into the bulk polymer matrix without additional binders. During solvent-based recycling, such pigments and fillers may dissolve, partially dissolve, or remain suspended as extremely fine particles within the dissolved polymer solution. Because these species are not associated with removable binder phases and may exist in molecular or colloidal form, they are substantially more difficult to remove using conventional mechanical separation techniques, such as filtration.

Disclosed herein are methods for removing pigments and other fillers from colored plastic waste by adding one or more compounds that function as “getters” into a dissolved polymer solution. The getters promote agglomeration and/or precipitation of pigments and other finely dispersed contaminants, thereby increasing their effective particle size and facilitating their removal through mechanical separation techniques such as filtration.

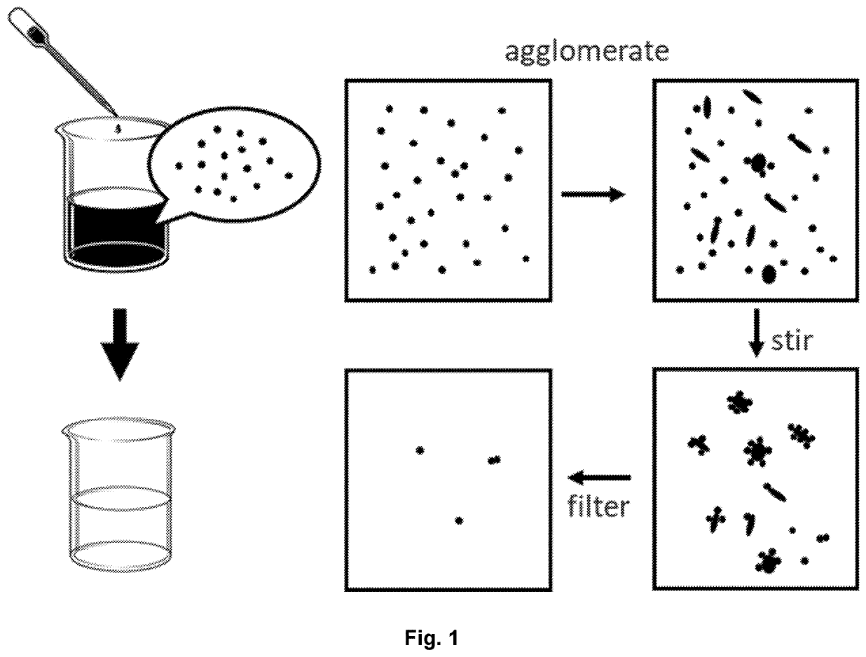

In certain embodiments, the agglomeration and/or precipitation results in formation of aggregates or precipitates having an effective particle size greater than that of the dispersed or dissolved colored contaminant prior to introduction of the getter. FIG. 1 shows a schematic diagram illustrating how the getter promotes agglomeration and/or precipitation of the contaminants so that they are more readily and more completely removed via mechanical filtration.

In certain embodiments, the getter comprises a polymeric material, including, but not limited to, polyurethane (PU), polyvinyl acetate (PVAc), polyvinyl alcohol (PVA), polyvinyl chloride (PVC), polypropylene (PP), high-density polyethylene (HDPE), other polyolefins, or combinations thereof. In some embodiments, the getter comprises a material suitable for use as an ink binder or adhesive.

The getter may be introduced directly as a separate additive or indirectly by mixing batches of plastic waste known to contain such materials. In certain embodiments, the getter is added in dissolved form. Alternatively, the getter may be introduced as a finely divided solid (e.g., a powder or particulate) to minimize introduction of additional solvent into the system.

The operating conditions are not particularly limited and may be selected based on the composition of the system. In certain embodiments, the getter material is present in an amount of about 0.1 wt % to about 40 wt % relative to the dissolved polymer. In some embodiments, the getter material is present in an amount of at least about 0.1 wt %, at least about 0.5 wt %, at least about 1 wt %, at least about 2 wt %, or at least about 5 wt %. In certain embodiments, the getter material is present in an amount of no more than about 40 wt %, no more than about 30 wt %, no more than about 25 wt %, no more than about 20 wt %, no more than about 10 wt %, or no more than 5 wt %, relative to the dissolved polymer.

The method may be conducted at elevated temperatures, for example, from about 50° C. to about 200° C. In certain embodiments, the getter material is added immediately following dissolution of the polymer in a hot solvent. The contacting time is likewise not particularly limited and may range, for example, from about 10 minutes to about 48 hours, and may be optimized based on the specific polymer, solvent, and getter employed. In certain embodiments, the contacting time is no more than about 18 hours, no more than about 10 hours, or no more than about 3 hours.

The disclosed method may be implemented in a variety of solvent-based plastic recycling processes. For example, in a solvent-targeted recovery and precipitation (STRAP) process, the getter may be added to the dissolved polymer stream prior to a filtration step when color removal is desired. In addition to pigments, the method may also be applied to remove other dispersed fillers, including carbon black, metal oxides, and similar particulate contaminants.

### Application in STRAP Processes

The STRAP process is a dissolution-based process that recycles multilayer plastic films and mixed plastic waste by using a series of solvents to selectively recover the constituent resins of the material guided by thermodynamic calculations of polymer solubility. In general, the STRAP process includes the following steps:
(a) using selective solvents to dissolve the target polymer to be recycled, while minimizing dissolution of pigments, binders, and other non-target polymer components of the raw plastic waste;
(b) separating the target polymer solution from the undissolved plastic waste by mechanical filtration;
(c) precipitating the target polymer and removing the solvent before drying; and
(d) cleaning the removed solvent with an adsorbent (so that the solvent itself can be recycled back into the STRAP process).

The STRAP process is described in detail in U.S. Patent Application Publication No. 2023/0174736 A1.

The methods disclosed herein may be implemented during the separation stage of the STRAP process, for example prior to or during step (b). In particular, addition of one or more compounds described herein as “getters” to the dissolved polymer solution promotes agglomeration and/or precipitation of colored inks, pigments, and other colored contaminants present in the dissolved mixture. Formation of larger aggregates or precipitates enhances removal of these contaminants by mechanical filtration. As a result, color removal from the recovered polymer is significantly improved.

An exemplary system suitable for carrying out the STRAP process is described in U.S. Patent Application Publication No. 2024/0059858 A1. The system can recycle a large variety of plastics from various sources such as flexible plastic films, multilayer plastic packaging waste, post-consumer plastic waste, post-industrial plastic waste, and municipal solid waste. In operation, the system selectively recovers one or more polymer components from multilayer films or mixed plastic waste streams. A first polymer component is recovered using a first solvent that selectively dissolves the first polymer component. The remaining undissolved plastics are then directed to one or more parallel subsystems to recover additional polymer components using corresponding selective solvents. In this manner, multiple polymer components may be sequentially recovered.

An exemplary STRAP system may include:
(i) a down-sizing device that shreds the plastic wastes and produces plastic particles having a size and aspect ratio to be flowable and easily dissolvable;
(ii) a feeder that conveys the plastic particles to a dissolution vessel in a constant flow without bridging;
(iii) a dissolution vessel for efficient mixing incoming plastic particles with one or more solvents, and draining the undissolved plastic particles and solvent (which contains a dissolved polymer component from the incoming feedstock);
(iv) a first filter (preferably a high-temperature or hot filter) that separates undissolved plastics from the solvent containing the dissolved polymer component;
(v) a precipitator to precipitate the dissolved polymer component;
(vi) a second filter (preferably a low-temperature or cold filter) that separates the precipitated polymer component from the solvent;
(vii) a solvent recovery unit that recovers solvents from wet plastics; and
(viii) an extruder that produces large quantities of recycled plastic resin pellets and removes the remaining traces of solvent from the recovered resin during the process.

During operation, plastic particles are introduced into the dissolution vessel and contacted with a selective solvent. The temperature of the vessel is controlled, typically at an elevated temperature, to promote dissolution of a targeted polymer component. The resulting plastic-solvent mixture is then directed to the hot filter, which separates undissolved solids from the liquid phase containing the dissolved polymer.

Plastic waste streams typically contain various inks and colorants, which may behave differently in the STRAP process. In general, these inks and colorants fall into three categories: (i) Those that dissolve in the selected solvent and remain soluble upon cooling. These inks and colorants will pass through filtration but do not co-precipitate with the recovered polymer; (ii) Those that dissolve in the selected solvent and co-precipitate with the target polymer upon cooling, thereby contaminating the recovered resin. Conventional STRAP processes may require an additional cycle using a different solvent to remove such impurities; (iii) Those that remain as dispersed micron-sized particles and can be removed using mechanical filtration, typically with filters ranging from about 1 to about 400 microns. The methods disclosed herein improve the STRAP process by facilitating agglomeration and/or precipitation of color contaminants. By increasing the effective particle size of dissolved or dispersed inks and colorants, the disclosed methods enhance their removability during filtration and subsequent separation steps. In certain embodiments, the treatment reduces the presence of all three categories of inks and colorants described above, potentially minimizing or eliminating the need for additional downstream purification steps.

### EXAMPLES

Provided below are exemplary getters suitable for use in the methods disclosed herein. These examples are illustrative and are not intended to limit the scope of getters that may be used. The temperature, contact time, and other processing parameters described in the examples may be varied and optimized based on the particular polymers, solvents, and colored contaminants present in a given system.

### Polyurethane (PU)

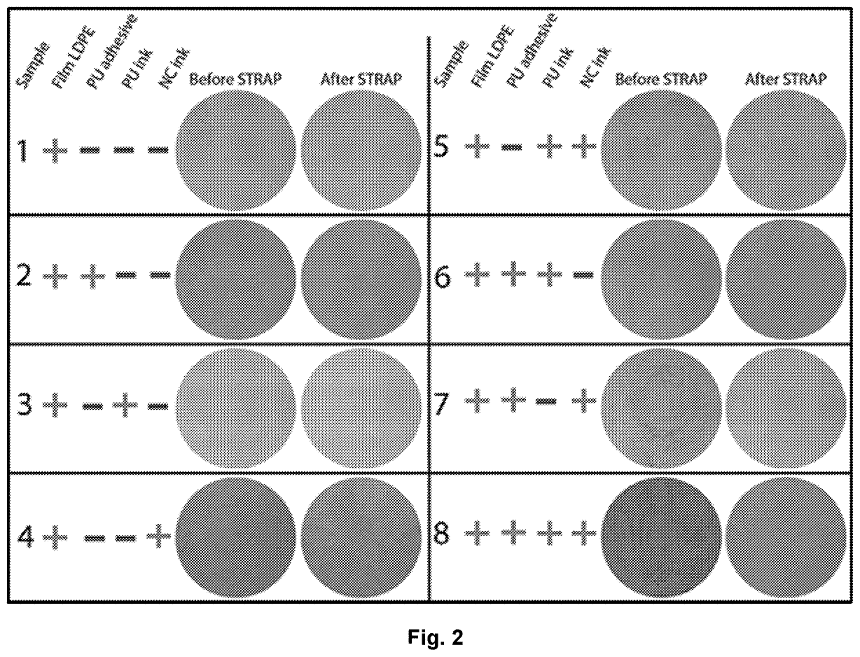

The behavior of polyurethane (PU) adhesives and ink binders was evaluated in a STRAP process. As shown in FIG. 2, eight samples comprising virgin LDPE plus various combinations of PU adhesive, PU ink, and/or nitrocellulose (NC) ink extenders (ink binders, solvents, and additives, i.e., inks without pigments) were prepared.

“Before STRAP” samples were hot pressed at 190° C., while “After STRAP” samples were dissolved in dodecane at 95° C., filtered with a 600-μm filter, precipitated at 25° C., dried under vacuum at 110° C., and hot pressed at 190° C. Compressed films of the samples before and after STRAP are shown in FIG. 2. Hot pressing of the LDPE films was performed by placing 0.75 g of polymer between two 6″× 6″ polytetrafluoroethylene (PTFE)-coated fiberglass sheets followed by two 6″×6″ aluminum sheets on the outside. A Carver Press 3970 was used to heat the sample at 190° C. without pressure for 1 min, followed by 3 metric tons of pressure for 1 min.

Sample 1 showed no yellowing before or after STRAP, indicating that degradation of the bulk polymer or any additives in the virgin resin is not the cause of yellowing. Slight yellowing was observed before STRAP for samples 2, 3, and 6, which is hard to see in FIG. 2. Samples 4, 5, 7, and 8 all show heavy yellowing before STRAP, indicating that NC ink causes this color change during the film hot compression. The PU adhesive and PU inks can also degrade but only form a slightly yellow color. Samples 2, 3, 6, 7, and 8 after STRAP showed no notable yellowing, while samples 4 and 5 after STRAP showed yellowing as in the pre-STRAP samples yet to a lesser degree.

These results demonstrate that STRAP effectively reduced the yellow color of all samples caused by insoluble PU and NC. The reason for samples 4 and 5 yellowing is that some of the small NC particles passed through the relatively coarse filter in this experiment. The difference between samples 4 and 5 and samples 7 and 8 is that samples 4 and 5 did not contain the PU adhesive. The PU adhesive thus binds to insoluble agglomerates and other insoluble components to help filter NC from the dissolved polymer.

An extended conclusion from the above STRAP experiments with adhesives and binders is that insoluble pigment particles can adhere to the ink binders and be removed more easily via filtration. Accordingly, it is hypothesized that at least some portion of the colored contaminants in the raw, dissolved plastic to be recycled can be agglomerated and/or precipitated by adding a “getter” compound or composition, such as PU, to the dissolved plastic solution. In this fashion, the contaminant particles are made larger and are therefore easier to remove via mechanical filtration.

In a first test, PU was evaluated as a potential getter for removal of colored contaminants from dissolved polyethylene (PE) solutions. PU is commonly present in multilayer plastic films as an adhesive and ink binder, and its use in a STRAP process could potentially be implemented without substantial additional cost.

The PE solution was prepared by fully dissolving a blue PE cap in dodecane at 120° C. to obtain an almost transparent blue solution. The cap material was selected due to its relatively simple composition, consisting primarily of PE and a blue pigment, without additional additives or binders. This system was used as a model for evaluating color removal using the getters.

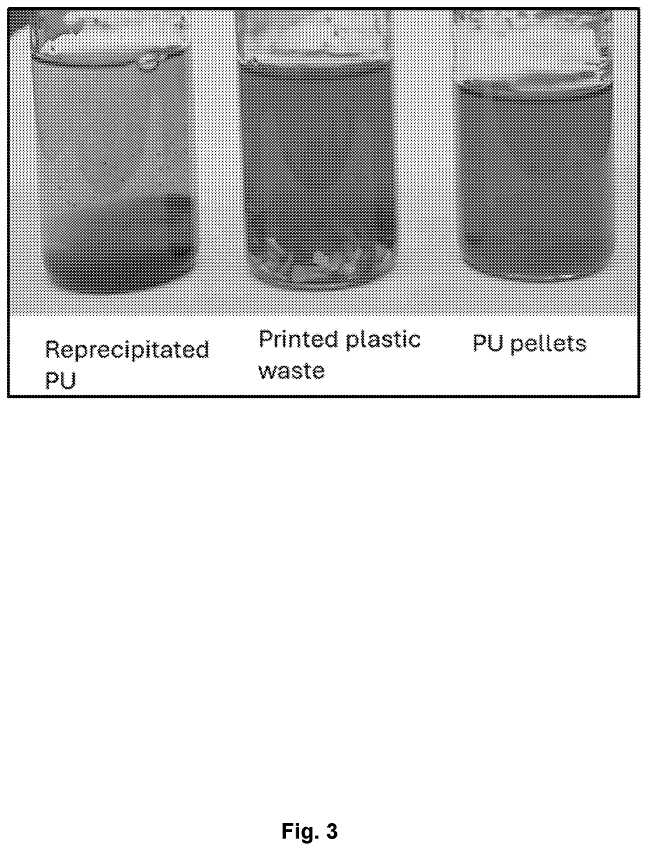

Three approaches were evaluated using 500 mg PE dissolved in 10 mL dodecane at 120° C. under stirring, and the results are shown in FIG. 3. In a first experiment, 100 mg of commercial PU pellets were added directly to the hot solution. The PU pellets developed slightly blue coloration, but the solution color remained largely unchanged. In a second experiment, PU pellets were dissolved in DMF and reprecipitated as fine powders before addition to the PE solution. The reprecipitated PU exhibited improved interaction with colored species, and the solution appeared less intensely colored compared to the pellet form. In a third experiment, 300 mg of printed multilayer film containing PU binders was introduced into the solution. The solution became lighter and slightly greener, and portions of the film surface developed a blue coloration.

These results indicate that PU can interact with pigment species and that increased surface area enhances effectiveness. However, complete color removal was not achieved under the tested conditions. Given the relatively low PU content in multilayer films, enrichment of PU or increased loading and contact time may improve performance.

In a second test, three experiments with better controlled conditions were conducted. In each experiment, 500 mg of blue PE was dissolved in 10 mL dodecane at 120° C. with stirring at about 800 rpm. PU pellets were first dissolved in DMF and added dropwise to the hot PE solution. The experimental conditions are summarized in Table 1:

TABLE 1
Experimental conditions for the second test.

| | | |
|---|---|---|
| Batch 1 | Batch 2 | Batch 3 |

| | | | | | | |
|---|---|---|---|---|---|---|
| Blue PE | 500 | mg | 500 | mg | 500 | mg |
| Dodecane (120° C.) | 10 | ml | 10 | ml | 10 | ml |
| PU solution added | 1 | ml | 0.5 | ml | 1 | ml |

| | | | |
|---|---|---|---|
| g PU/ml DMF | 0.1 | 0.1 | 0.05 |

| | | | | | | |
|---|---|---|---|---|---|---|
| Stir time | 18 | h | 18 | h | 18 | h |

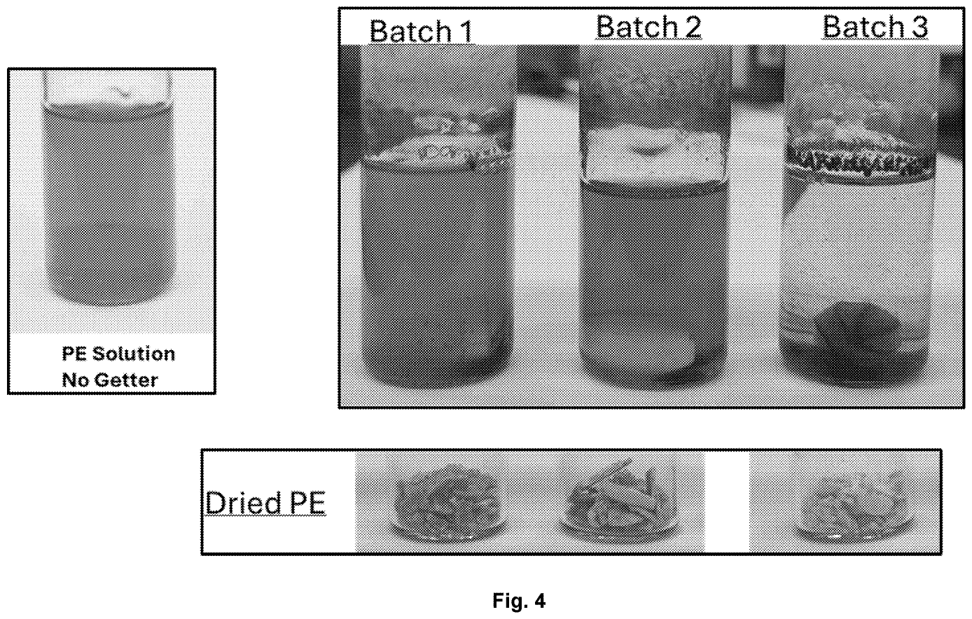

For Batches 1 and 2, a PU solution containing 1 g PU in 10 mL DMF was used. Batch 1 received 1 mL (~100 mg PU), and Batch 2 received 0.5 mL (~50 mg PU). The viscous PU solution did not reprecipitate efficiently and largely adhered to the bottom of the vessel (see FIG. 4). The photos were taken of the hot plastic solution after adding PU.

In Batch 3, the PU solution was diluted to 1 g PU in 20 mL DMF, and 1 mL (~50 mg PU) was added. As shown in FIG. 4, reprecipitation improved relative to Batches 1 and 2, although some aggregation of PU was still observed.

After 18 hours of stirring, the hot solutions were then filtered through a coarse mesh to remove PU and adhered pigments. As further shown in FIG. 4, the dried PE recovered from Batches 1 and 2 exhibited reduced blue coloration, while the dried PE recovered from Batch 3 showed greater color reduction. These results indicate that 18 hours and 10 wt % PU appear more than enough for removing the color from blue PE solution.

In a third test, lower PU loading, lower PU solution concentrations, and shorter contact time were evaluated. The experimental conditions are summarized in Table 2:

TABLE 2
Experimental conditions for the third test.

| | 1/20 PU/DMF | | 1/40 PU/DMF | | 1/80 PU/DMF | | 1/160 PU/DMF | |
|---|---|---|---|---|---|---|---|---|
| Blue PE | 500 | mg | 500 | mg | 500 | mg | 500 | mg |
| Dodecane (120° C.) | 10 | ml | 10 | ml | 10 | ml | 10 | ml |
| PU solution added | 1 | ml | 1 | ml | 1 | ml | 1 | ml |

| | | | | |
|---|---|---|---|---|
| g PU/ml DMF | 0.05 | 0.025 | 0.0125 | 0.00625 |
| Stir time | 10 min, 30 min, | 10 min, 30 min, | 10 min, 30 min, | 10 min, 30 min, |
| | 3 h, 18 h | 3 h, 18 h | 3 h, 18 h | 3 h, 18 h |

PU/DMF solutions were prepared at mass-to-volume ratios of 1/20, 1/40, 1/80, and 1/160, and 1 mL of each solution was added to hot PE/dodecane solutions. Color evolution was monitored at about 10 minutes, 30 minutes, 3 hours, and 18 hours.

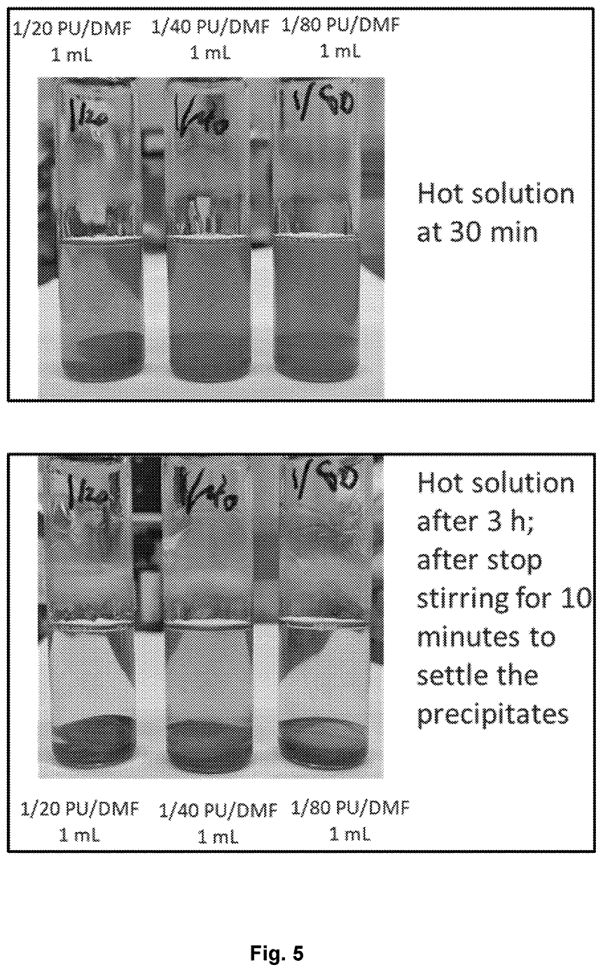

As shown in FIG. 5, reducing PU solution concentration relative to the second test improved reprecipitation behavior, resulting in fewer large PU aggregates. At higher dilutions ( 1/80 and 1/160), occasional phase separation between DMF and dodecane was observed. Visible enrichment of blue color into PU particles occurred within about 10 minutes. Notably, prolonged agitation was not necessary for effective interaction. The hot solutions at 30 minutes appeared visually similar to those at 10 minutes, and samples evaluated after 3 hours (following 10 minutes of settling) were visually similar to those after 18 hours. Increasing PU concentration (e.g., 1/40) did not consistently improve color removal.

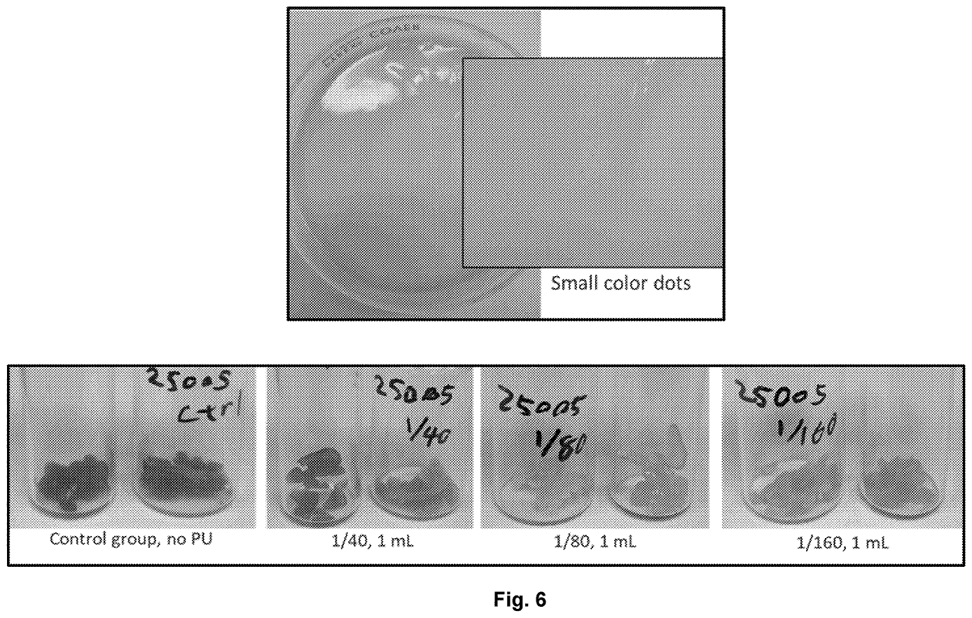

Following agitation, the hot PE+PU mixtures were subjected to rough filtration through a metal mesh. Most of the PU remained adhered to the vessel walls or was retained by the mesh. The resulting PE slurry exhibited only a light blue-green color. The slight greenish color observed in the dried PE appeared to be associated with thermal discoloration of DMF during heating. This effect may be mitigated by replacing DMF with an alternative solvent, such as γ-valerolactone (GVL). A small amount of fine blue precipitate passed through the mesh into the slurry (FIG. 6, upper panel), suggesting that finer filtration would likely further enhance removal.

After cooling, the PE slurry was vacuum-filtered and washed with acetone. No noticeable color was removed during the acetone wash, indicating that the remaining coloration was not attributable to readily soluble species. The filtered PE was then vacuum-dried.

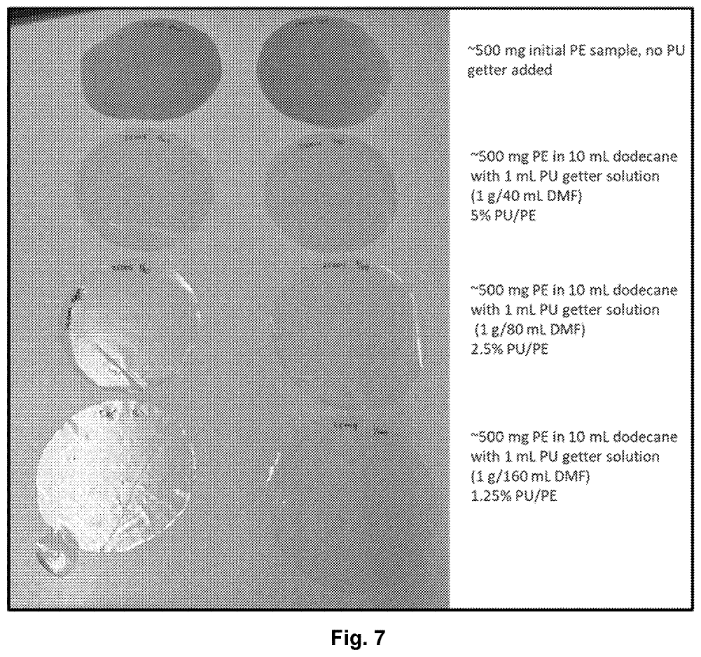

As shown in FIG. 6 (lower panel), substantial color removal was achieved relative to untreated blue PE, with the 1/160 PU/DMF (1 mL) condition exhibiting the greatest apparent color removal among the tested conditions. Films cast from treated PE (FIG. 7) exhibited markedly improved visual appearance compared to films prepared without the getter treatment, even when minor residual color specks were present.

### Polypropylene (PP)

Polypropylene (PP) is often soluble in the same solvents as polyethylene. Differences in molecular weight, structure, crystallinity can affect the solubility, and be used to manipulate the solubility of specific polyolefin species in a mixture of polyolefins. In this example, PP was added to LDPE to act as a getter, removing TiO₂, an inorganic white pigment. Virgin LDPE was compounded with 3 wt % of a TiO₂ masterbatch. The masterbatch itself contained 70 wt % TiO₂ and 30 wt % PE. The final concentration of TiO₂ in the LDPE was 2 wt %.

The LDPE-TiO₂ was dissolved in n-octane at 125° C. as shown in Table 3. Next, PP was added to the solution. Both LDPE and PP were soluble in n-octane at 125° C. After dissolution of the PP, stirring was stopped, and the solution was allowed to cool to 70° C. to precipitate both LDPE and PP. Following precipitation, the solution was reheated to 90° C., where the LDPE was soluble, but the PP was not. The solution was then filtered at 90° C. through a 25-μm filter.

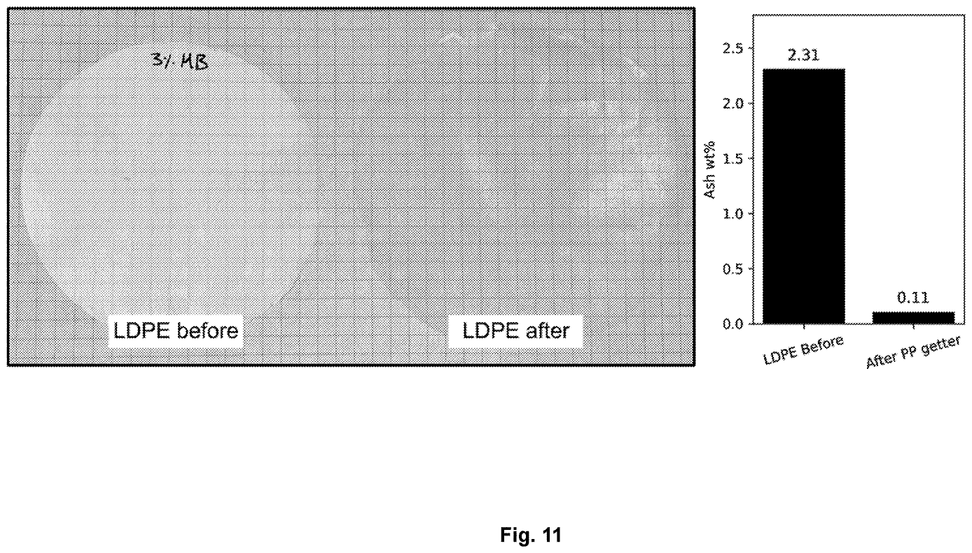

Ash content analysis, following ASTM D5630, was used to measure the TiO₂ content in LDPE samples before and after STRAP. A decrease in ash (TiO₂) content was observed in the samples with PP. Compressed films of the samples also show a clear transition from opaque white before STRAP to clear after STRAP (FIG. 11).

These results indicate that the PP can effectively trap the TiO₂ particles and can be separated from the bulk solution during filtration. The “STRAP control” shows that without the addition of PP, TiO₂ passes through the filter into the filtrate.

TABLE 3
Experimental conditions for PP examples
(dissolution temperature 125° C.).

| | n-octane | LDPE - TiO₂ | PP added | Polymer Ash |
|---|---|---|---|---|
| | (ml) | (gm) | (gm) | wt % |
| Feed | — | 4.0 | — | 2.03 |
| STRAP Control | 50 | 5.0 | 0 | 2.31 |
| Exp 1 | 50 | 5.0 | 0.56 | 0.11 |
| Exp 2 | 100 | 10.0 | 0.69 | 0.19 |

### Commercial Adhesives

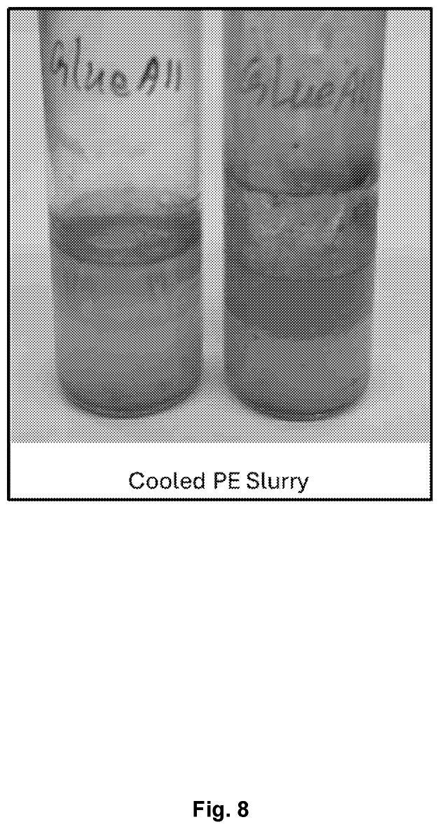

FIG. 8 shows the results of using a mixture of polyvinyl acetate, polyvinyl alcohol, and propylene glycol in a water emulsion as the “getter.” This mixture was the commercially available Elmer's® Glue-All®-brand glue.

In the experiment, about 100-200 mg of the adhesive was added to a hot PE/dodecane solution containing 500 mg of PE dissolved in 10 mL dodecanes at 120° C. The system exhibited phase separation, likely due to the presence of water or alcohol components in the adhesive, as indicated by boiling below 120° C. After overnight stirring, the blue coloration migrated to the vessel walls and bottom. Upon cooling, the resulting PE slurry appeared nearly colorless.

### Polyvinyl Acetate (PVAc)

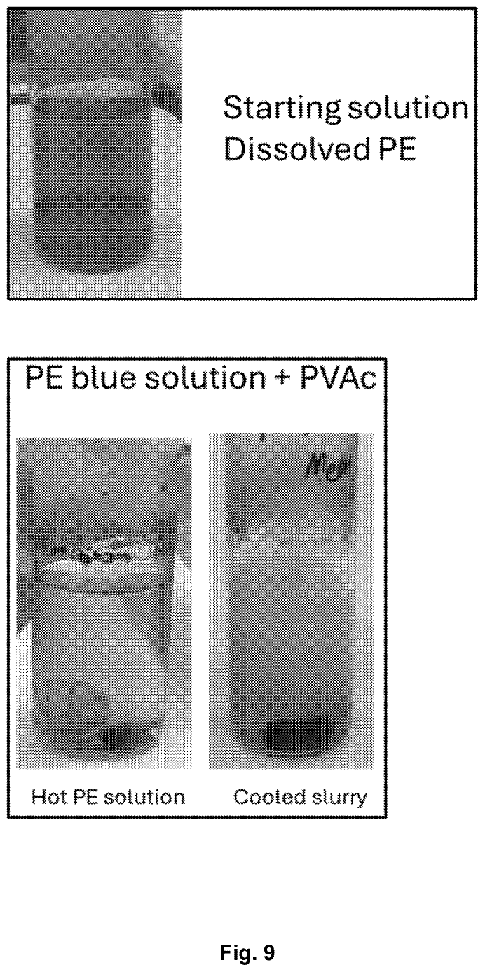

FIG. 9 depicts another example using PVAc as the “getter.” The PVAc was introduced as a 10 wt % solution in ethyl acetate. About 0.5-1 mL of this solution (corresponding to about 50-100 mg PVAc) was added to a hot PE/dodecane solution. The ethyl acetate rapidly evaporated under the reaction conditions, resulting in reprecipitation of PVAc within the system. After prolonged stirring, the PVAc aggregated into a cohesive mass exhibiting a deeper blue color. Concurrently, the solution color became noticeably lighter, and the cooled PE slurry also showed reduced coloration.

### Polyvinyl Chloride (PVC)

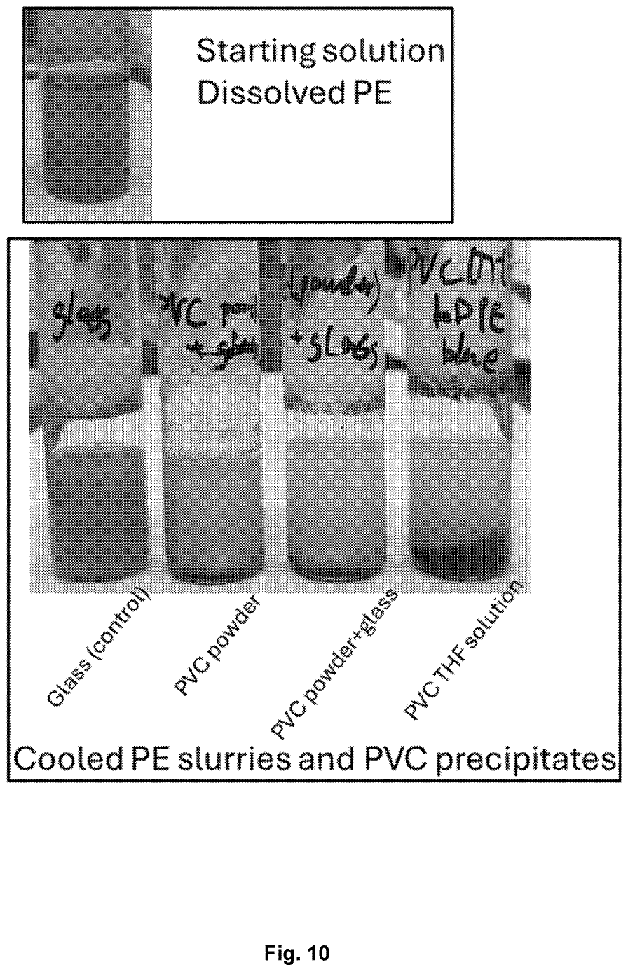

FIG. 10 depicts yet another example using PVC as the “getter.” When PVC powder was added to the hot blue PE/dodecane solution with heating and stirring, partial color removal was observed. Color removal appeared to improve when PVC powder was added together with glass beads (~0.5 mm) during agitation. Without being bound by theory, the improvement may be related to enhanced interaction between PVC and pigment particles under the agitation condition. Further improvement was observed when PVC was introduced as a tetrahydrofuran (THF) solution rather than as a dry powder. Upon addition to the dodecane system, PVC reprecipitated as a more dispersed, fluffy solid, which appeared to enhance contact with pigment species and further reduce solution color.

What is claimed is:

1. A method of removing colored contaminants from a solution comprising a dissolved polymer and at least one colored contaminant, the method comprising:
(a) adding to the solution a getter material in an amount and for a time and at a temperature wherein at least a portion of a colored contaminant in the solution is agglomerated and/or precipitated, thereby yielding a treated solution.

2. The method of claim 1, further comprising, after step (a):
(b) filtering the treated solution to remove at least a portion of the agglomerated and/or precipitated colored contaminant.

3. The method of claim 1, wherein the getter material comprises a material suitable for use as an ink binder or adhesive.

4. The method of claim 1, wherein the getter material comprises a polymer.

5. The method of claim 4, wherein the polymer is a synthetic organic polymer.

6. The method of claim 4, where the polymer is selected from the group consisting of polyurethane (PU), polyvinyl acetate (PVAc), polyvinyl alcohol (PVA), polyvinyl chloride (PVC), polypropylene (PP), high-density polyethylene (HDPE), other polyolefins, and combinations thereof.

7. The method of claim 1, wherein the getter material is added in the form of a liquid solution.

8. The method of claim 7, wherein the getter material is dissolved in a second solvent prior to addition to the solution.

9. The method of claim 8, wherein the getter material reprecipitates upon contact with the solution.

10. The method of claim 1, wherein the getter material is added in solid form.

11. The method of claim 1, wherein the getter material is added by adding a waste stream comprising the getter material.

12. The method of claim 1, wherein the getter material is added in an amount of about 0.1 wt % to about 40 wt % relative to the dissolved polymer.

13. The method of claim 1, wherein the temperature of step (a) is about 50° C. to about 200° C.

14. The method of claim 1, wherein the time of step (a) is about 10 minutes to about 48 hours.

15. The method of claim 1, wherein step (a) is conducted with agitation.

16. The method of claim 15, wherein the agitation is conducted in the presence of an inert solid agitation media.

17. The method of claim 2, further comprising, after step (b):
(c) precipitating at least a portion of the dissolved polymer from the filtered solution.

18. The method of claim 1, wherein the dissolved polymer is derived from multilayer plastic films or mixed plastic wastes.

19. The method of claim 1, wherein the dissolved polymer comprises a polyolefin.
